(19) United States
(12) Patent Application Publication
(10) Pub. No.: US 2011/0205600 A1
(43) Pub. Date: Aug. 25, 2011

(54) OPTICAL SCANNING APPARATUS, DRIVE CONTROL CIRCUIT, AND WRITING CONTROL METHOD

(75) Inventor: RIICHIRO HIBIYA, Tokyo (JP)

(73) Assignee: MITSUMI ELECTRIC CO., LTD., Tokyo (JP)

(21) Appl. No.: 13/031,660

(22) Filed: Feb. 22, 2011

(30) Foreign Application Priority Data
Feb. 23, 2010 (JP) 2010-037290
Sep. 30, 2010 (JP) 2010-222287

(51) Int. Cl. H04N 1/04; G02B 26/10

(52) U.S. Cl. 358/474; 359/199.1; 359/199.4

(57) ABSTRACT

An optical scanning apparatus for projecting an image by scanning a light beam from a light source includes a mirror for scanning the light beam from the light source by being oscillated at resonance frequency and a drive control part controlling a timing for activating the light source. The drive control part includes a mirror drive voltage generation part for generating a mirror drive voltage for oscillating the mirror, a sinusoidal wave value storage part for storing a sinusoidal wave value used for generating the mirror drive voltage, an address counter for counting an address of the sinusoidal wave storage part, and a timing signal generation part for outputting a timing signal to control the timing for activating the light source to the drive control part. The timing signal generation part is for outputting the timing signal when the address of the sinusoidal wave storage part matches a predetermined address.

### BACKGROUND OF THE INVENTION

1. Field of the Invention

The present invention generally relates to an optical scanning apparatus, a drive control circuit, and a writing control method.

2. Description of the Related Art

Conventionally, there is known a piezoelectric type mirror used for scanning reflected light by changing a relative angle between a mirror and a direction of incident light incident on the mirror. The relative angle between the mirror and the direction of the incident light is changed by oscillating the mirror with a piezoelectric element. The piezoelectric type mirror is supported by a cantilever provided with the piezoelectric element. The cantilever is displaced by applying a mirror drive voltage to the piezoelectric element. The displacement of the cantilever causes the piezoelectric type mirror to oscillate.

The piezoelectric type mirror is typically oscillated by utilizing resonance frequency (sympathetic vibration). Therefore, due to a temperature dependent characteristic of the resonance frequency, the displacement of the piezoelectric type mirror changes in accordance with the atmospheric temperature in which the mirror is used. The changes of the piezoelectric type mirror cause a phase difference between the mirror drive voltage and the actual displacement of the piezoelectric type mirror. FIG. 1 is a graph illustrating the phase difference occurring between the mirror drive voltage and the displacement of the piezoelectric type mirror.

The piezoelectric type mirror is mounted on an optical scanning apparatus (e.g., projector) and used as a laser beam reflecting surface for projecting image data to a screen or the like. In this case, the piezoelectric type mirror reflects a laser beam by driving the piezoelectric type mirror in correspondence with the timing of writing the image data and causing the piezoelectric type mirror to be displaced with respect to a desired direction.

In a case where there is a phase difference between the mirror drive voltage and the displacement of the piezoelectric type mirror as illustrated in FIG. 1, the phase difference causes a time difference (deviation) between the timing of applying the mirror drive voltage and the timing of the actual displacement of the piezoelectric type mirror. Such time difference causes deviation of an image projected on a screen or the like as illustrated in FIG. 2B. FIG. 2A illustrates an example of an image where there is no phase difference between the mirror drive voltage and the displacement of the piezoelectric type mirror.

Accordingly, in order to resolve the deviation of the projected image, the writing of image data is to be started in view of the time difference caused by the phase difference between the mirror drive voltage and the displacement of the piezoelectric type mirror. For example, Japanese Laid-Open Patent Publication No. 2008-310289 discloses a method of generating drive signals for causing an oscillation system to operate as desired.

An optical scanning apparatus 10 according to a related art example is described with reference to FIG. 3. FIG. 3 is a schematic diagram illustrating the optical scanning apparatus 10 of the related art example. The optical scanning apparatus 10 includes a mirror drive circuit 11, a mirror (piezoelectric drive mirror) 12, a mirror position detection circuit 13, a mirror position trigger 14, a laser diode (LD) drive circuit 15, and a laser diode 16. Because there is a phase difference between the mirror drive voltage and the displacement of the mirror 12 (as illustrated in FIG. 1) with the optical scanning apparatus 10 of the related art example, the writing of image data is started by detecting the position (displacement) of the mirror with the mirror position detection circuit 13 and controlling the laser diode 16 with the LD drive circuit 15 triggered by the mirror position detection signal (see FIG. 1) output from the mirror position trigger 14.

With the optical scanning apparatus 10 of the related art example, the writing of image data is started when the laser diode 16 is illuminated (turned on to emit) after determining the timing of illuminating the laser diode 16 in accordance with the results of detecting the position (displacement) of the mirror 12. In other words, with the optical scanning apparatus 10 of the related art example, the timing of illuminating the laser diode 16 is the timing in which the writing of image data is started. Therefore, in order to determine the timing of starting the writing of image data, a detection device is needed to be provided in the optical scanning apparatus 10 of the related art example for detecting displacement of the mirror with high precision. However, providing such a detecting device complicates the configuration of the optical scanning apparatus 10.

### SUMMARY OF THE INVENTION

The present invention may provide an optical scanning apparatus, a drive control circuit, and a writing control method that substantially eliminate one or more of the problems caused by the limitations and disadvantages of the related art.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by an optical scanning apparatus, a drive control circuit, and a writing control method particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides an optical scanning apparatus for projecting an image by scanning a light beam from a light source, the optical scanning apparatus including: a mirror configured to scan the light beam from the light source by being oscillated by resonance frequency; and a drive control part configured to control a timing for activating the light source; wherein the drive control part includes a mirror drive voltage generation part configured to generate a mirror drive voltage for oscillating the mirror; a sinusoidal wave value storage part configured to store a sinusoidal wave value used for generating the mirror drive voltage; an address counter configured to count an address of the sinusoidal wave storage part; and a timing signal generation part configured to output a timing signal to control the timing for activating the light source to the drive control part; wherein the timing signal generation part is configured to output the timing signal when the address of the sinusoidal wave storage part matches a predetermined address.

Other objects and further features of the present invention will become apparent from the following detailed description when read in conjunction with the accompanying drawings.

### BRIEF DESCRIPTION OF THE DRAWINGS

FIG. 1 is a graph illustrating a phase difference occurring between a mirror drive voltage and displacement of a piezoelectric type mirror;

FIG. 2A illustrates an example of an image where there is no phase difference between a mirror drive voltage and displacement of a piezoelectric type mirror;

FIG. 25 illustrates an example of an image where there is phase difference between a mirror drive voltage and displacement of a piezoelectric type mirror;

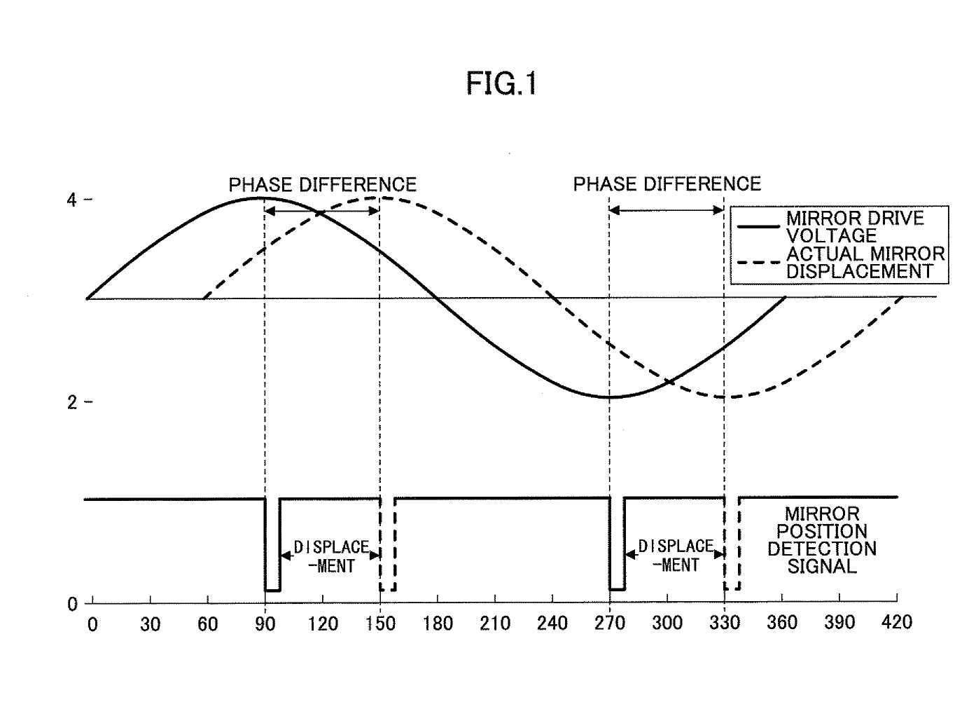

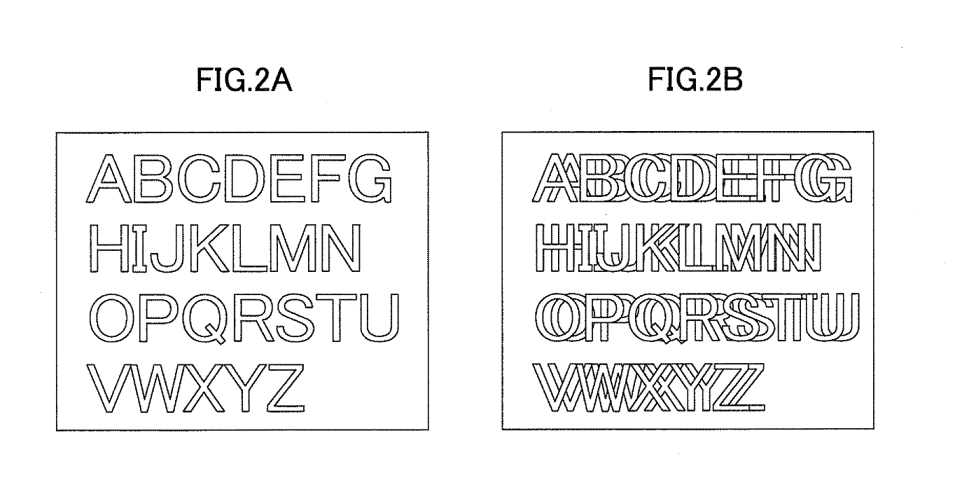

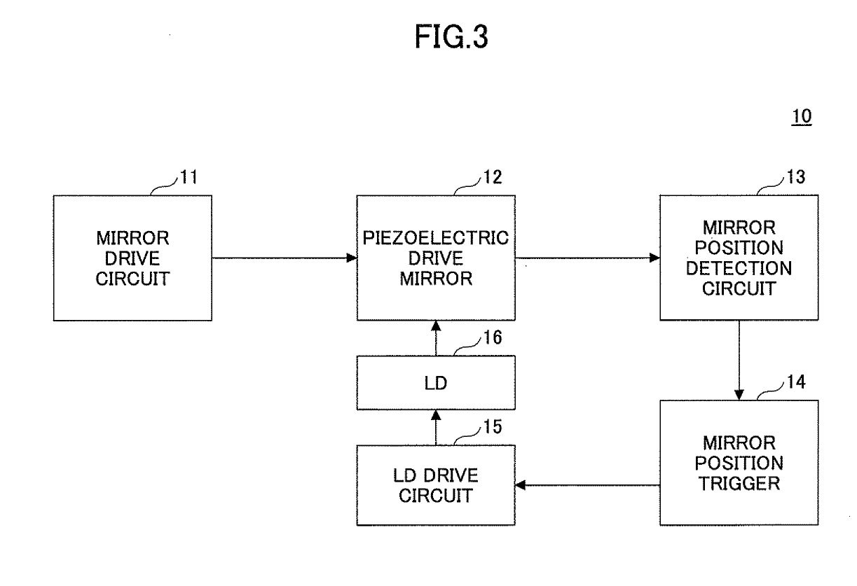

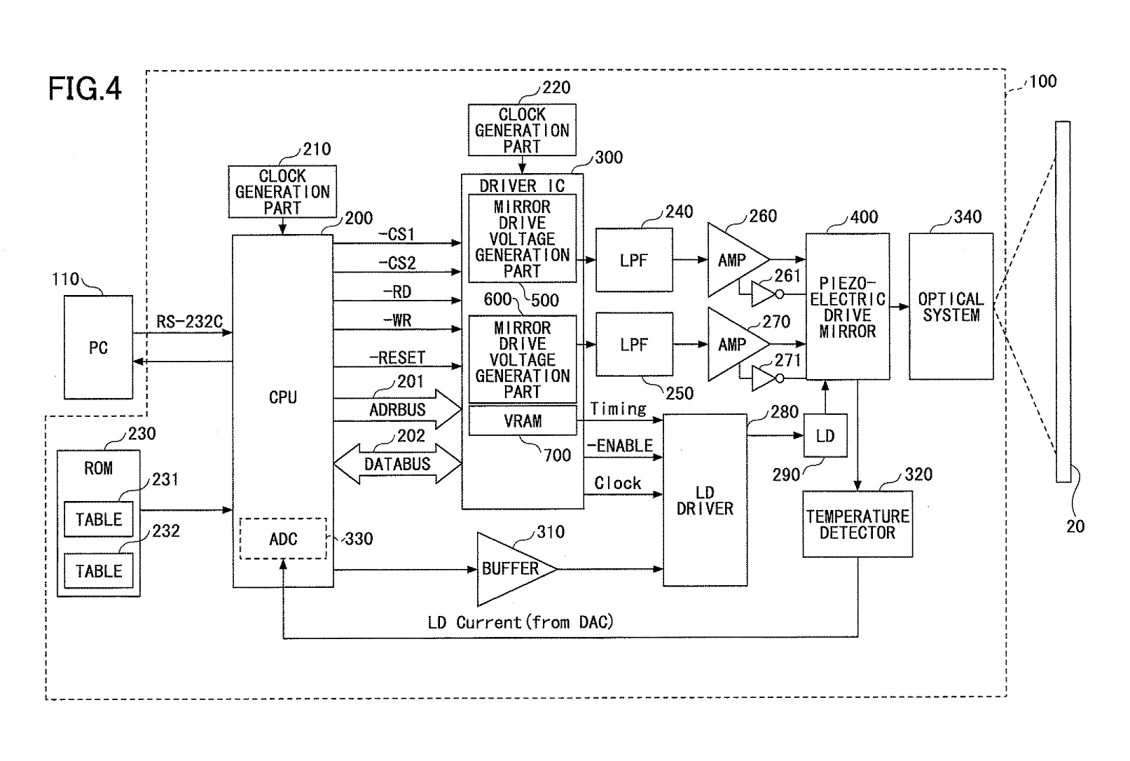

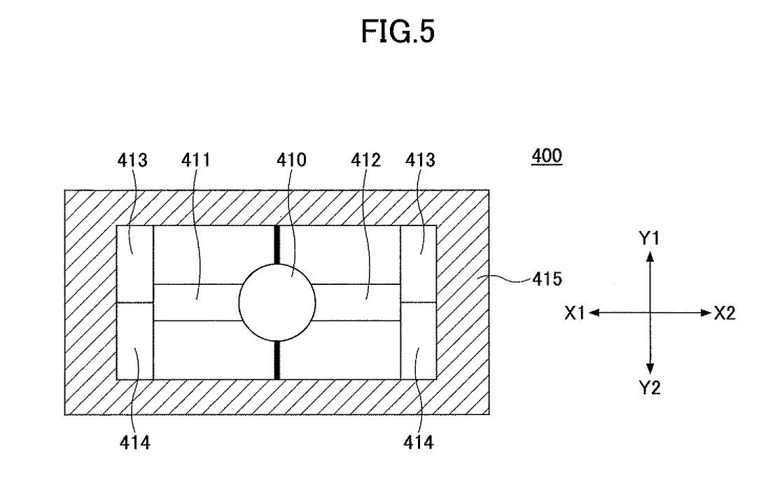

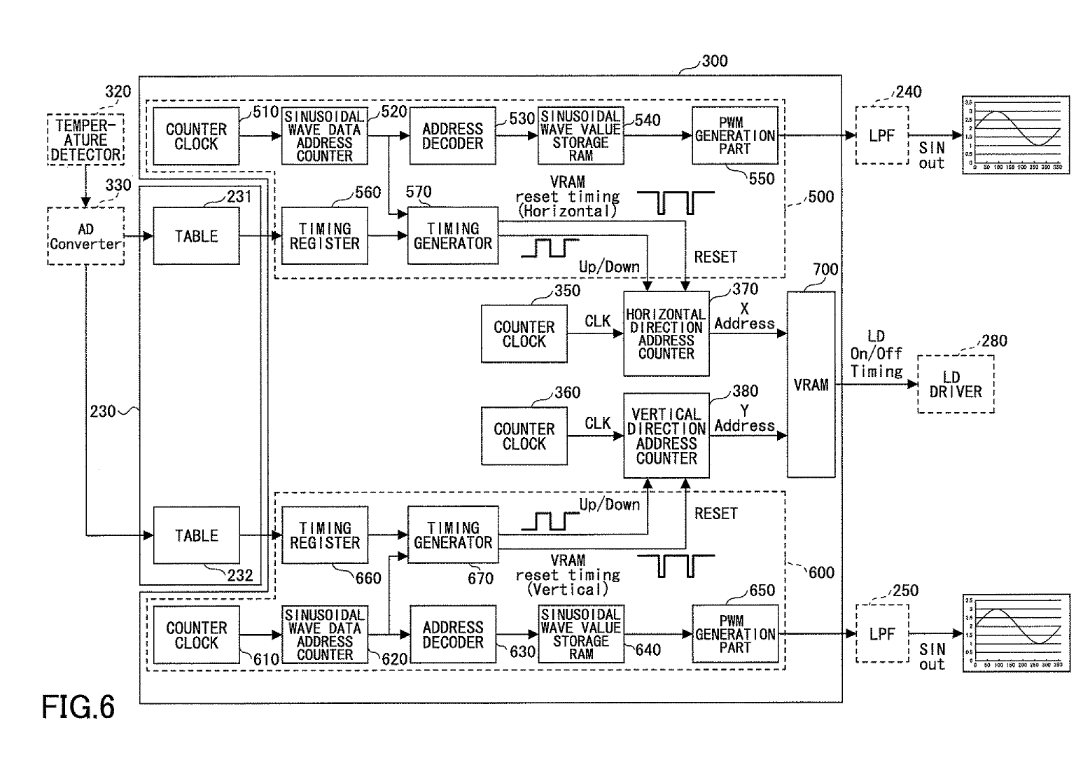

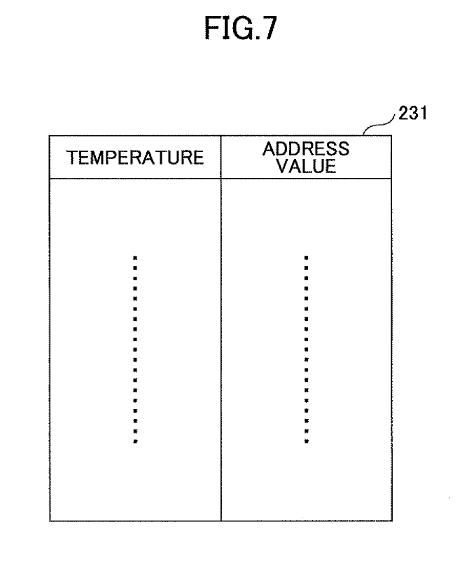

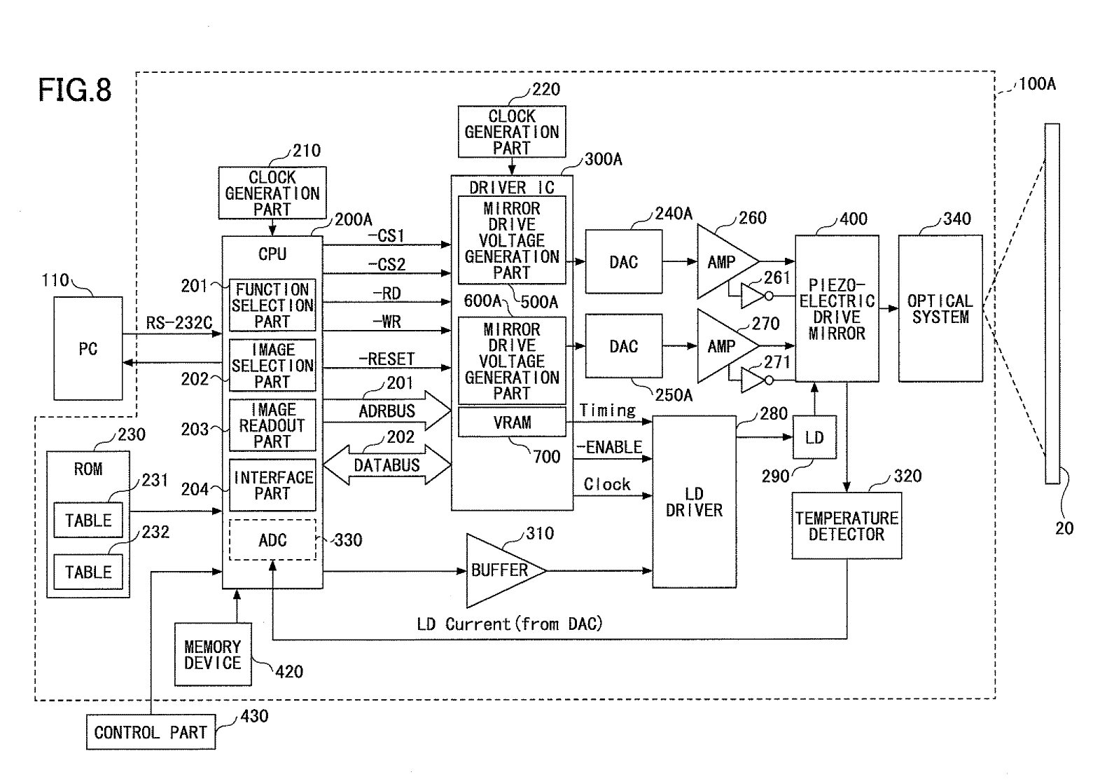

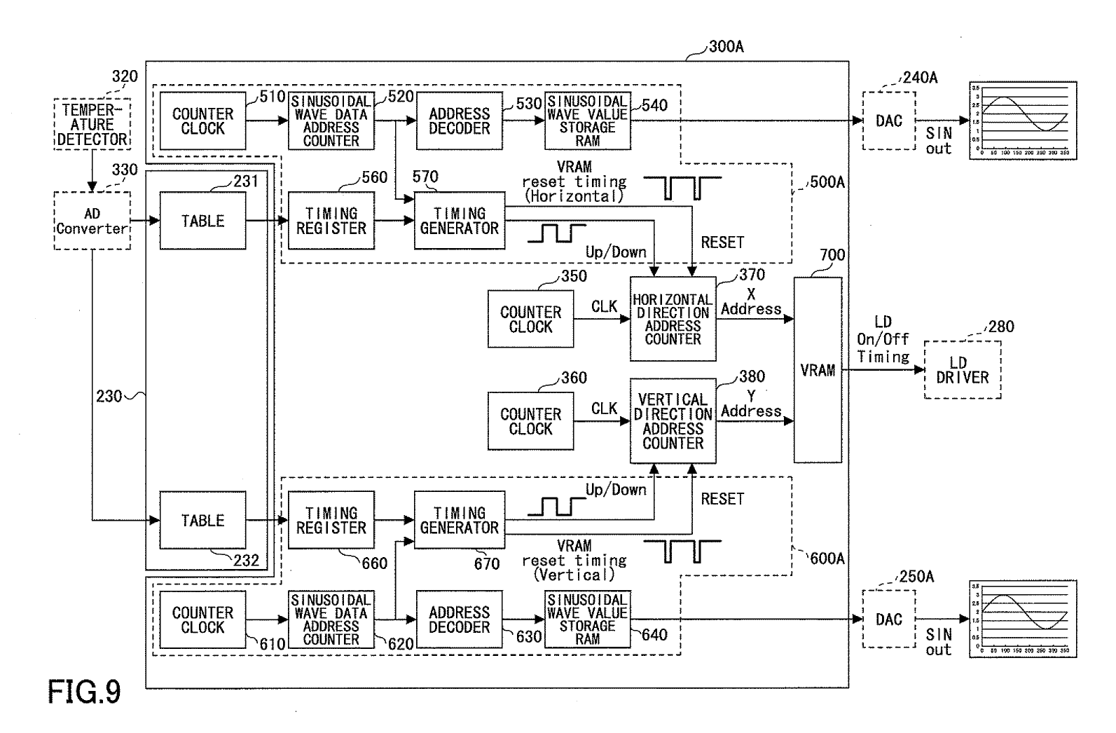

FIG. 3 is a schematic diagram illustrating an optical scanning apparatus of a related art example;

FIG. 4 is a schematic diagram illustrating an optical scanning apparatus according to a first embodiment of the present invention;

FIG. 5 is a schematic diagram illustrating a piezoelectric type mirror according to an embodiment of the present invention;

FIG. 6 is a schematic diagram illustrating a driver IC according to the first embodiment of the present invention;

FIG. 7 illustrates an example of a table stored in a ROM according to an embodiment of the present invention;

FIG. 8 is a schematic diagram illustrating an optical scanning apparatus according to a second embodiment of the present invention; and

FIG. 9 is a schematic diagram illustrating a driver IC 300A according to the second embodiment of the present invention.

### DESCRIPTION OF THE PREFERRED EMBODIMENTS

In the following, embodiments of the present invention will be described with reference to the accompanying drawings.

### First Embodiment

An optical scanning apparatus 100 according to the first embodiment of the present invention is described with reference to FIG. 4. FIG. 4 is a schematic diagram illustrating the optical scanning apparatus 100 according to the first embodiment of the present invention.

The optical scanning apparatus 100 according to the first embodiment includes a CPU (Central Processing Unit) 200, clock generation parts 210, 220, a ROM (Read Only Memory) 230, LPFs (low pass filters) 240, 250, AMPs (amplifiers) 260, 270, inverters 261, 271, a LD (laser diode) driver 280, a LD (laser diode) 290, a driver IC (integrated circuit) 300, a buffer 310, a temperature detector (temperature detection part) 320, an ADC (analog to digital converter) 330, an optical system 340, and a piezoelectric type mirror (piezoelectric drive mirror) 400.

In the optical scanning apparatus 100, the CPU 200 controls the driver IC 300 based on image data transmitted from a PC (personal computer) 110. The driver IC 300 is a drive control circuit that drives the piezoelectric type mirror 400. More specifically, in this embodiment, the driver IC 300 oscillates the piezoelectric type mirror 400 by supplying a mirror drive voltage in correspondence with the image data transmitted by the PC 110.

The piezoelectric type mirror 400 according to an embodiment of the present invention is described with reference to FIG. 5. FIG. 5 is a schematic diagram illustrating the piezoelectric type mirror 400 according to an embodiment of the present invention.

The piezoelectric type mirror 400 according to an embodiment of the present invention includes first cantilevers 411, 412 for oscillating a mirror part 410 in X1-X2 directions and second cantilevers 413, 414 for oscillating the mirror part 410 in Y1-Y2 directions. The second cantilevers 413, 414 oscillate the mirror part 410 in Y1-Y2 directions together with the first cantilevers 411, 412.

The first cantilevers 411, 412 are positioned one on each side of the mirror part 410. That is, the mirror part 410 is disposed in-between the first cantilevers 411, 412. The first cantilevers 411, 412 are supported by an outer frame 415 via the second cantilevers 413, 414.

Each of the first cantilevers 411, 412 includes a piezoelectric element (not illustrated). The piezoelectric element is displaced by applying a voltage to the piezoelectric element. Accordingly, the first cantilevers 411, 412 are displaced in correspondence with the displacement of corresponding piezoelectric elements. The mirror part 410 oscillates in the X1-X2 directions in accordance with the displacement of the first cantilevers 411, 412. In this embodiment, voltage (mirror drive voltage) is applied to the piezoelectric elements of the first cantilevers 411, 412 from the driver IC 300. In the following description, the applying of mirror drive voltage to the piezoelectric elements of the first cantilevers 411, 412 may also be referred to as “supplying mirror drive voltage to the first cantilevers 411, 412”.

The second cantilevers 413, 414 also include piezoelectric elements, respectively. The piezoelectric element is displaced by applying voltage to the piezoelectric element. Accordingly, the second cantilevers 413, 414 are displaced in correspondence with the displacement of corresponding piezoelectric elements. The mirror part 410 oscillates in the Y1-Y2 directions in accordance with the displacement of the second cantilevers 411, 412. In this embodiment, voltage (mirror drive voltage) is applied to the piezoelectric elements of the second cantilevers 413, 414 from the driver IC 300.

That is, the piezoelectric type mirror 400 oscillates the mirror part 410 in vertical and horizontal directions. The piezoelectric type mirror 400 moving the mirror part 410 in the vertical and horizontal directions is also referred to as a biaxial piezoelectric type mirror.

Returning to the description of the optical scanning apparatus 100, the CPU 200 is for controlling the entire operations/processes of the optical scanning apparatus 100.

Next, details of the controls performed by the CPU 200 are described. The clock generation part 210 generates clock signals and supplies the clock signals to the CPU 200. The clock generation part 220 generates clock signals and supplies the clock signals to the driver IC 300. The ROM 230 has tables 231, 232 stored therein. The table 231 indicates predetermined address values in correspondence with the temperature of the mirror part 410. The predetermined address value of the table 231 indicates an address in which a sinusoidal wave value corresponding to the phase difference between the mirror drive voltage for the X1-X2 direction and the displacement of the mirror part 410 is stored. The table 232 also indicates predetermined address values in correspondence with the temperatures of the mirror part 410. The predetermined address value of the table 232 indicates an address in which a sinusoidal wave value corresponding to the phase difference between the mirror drive voltage for the Y1-Y2 direction and the displacement of the mirror part 410 is stored. It is to be noted that the sinusoidal wave value is used for generating a mirror drive voltage having a sinusoidal wave shape. For example, the sinusoidal wave value may be a PWM (Pulse Width Modulation) duty value.

The driver IC 300 outputs a mirror drive voltage for driving the piezoelectric type mirror 400. The driver IC 300 includes a mirror drive voltage generation parts 500, 600 and a VRAM (Video Random Access Memory) 700. The mirror drive voltages generated by the mirror drive voltage generation parts 500, 600 are supplied to the piezoelectric type mirror 400 via the LPFs 240, 250, the AMPs 260, 270, and the inverters 261, 271, respectively.

More specifically, for example, the mirror drive voltages output from the mirror drive voltage generation part 500 are supplied to the first cantilever 411 via the LPF 240 and the AMP 260. Further, the mirror drive voltages output from the AMP 260 are inverted by the inverter 261, so that the mirror drive voltages become signals with a phase shifted 180 degrees. Then, the inverted mirror drive voltages are supplied to the first cantilever 412. The mirror drive voltages output from the mirror drive voltage generation part 600 are supplied to the second cantilevers 413 via the LPF 250 and the AMP 270. Further, the mirror drive voltages output from the AMP 270 are inverted by the inverter 271, so that the mirror drive voltages become signals with a phase shifted 180 degrees. Then, the inverted mirror drive voltages are supplied to the second cantilevers 414.

The CPU 200 records (stores) image data transmitted from the PC 110 in the VRAM 700.

The LD driver 280 controls the laser diode 290 based on the image data. The LD driver 280 according to an embodiment of the present invention starts (activates) the driving (illumination) of the LD 290 upon receiving a timing signal from the driver IC 300 indicative of the timing for starting the writing of the image data. The LD 290 is a light source for irradiating a beam(s) of light (in this case, a laser beam) to the mirror part 410 of the piezoelectric type mirror 400. The LD 290 illuminates (emits) upon receiving an instruction from the LD driver 280 to start driving (illumination).

The buffer 310 supplies a signal defining a maximum current to the LD 290 from the CPU 200.

The temperature detector 320 detects the temperature of the piezoelectric type mirror 400. The detection results of the temperature detector 320 are converted to digital signals by the ADC 330 of the CPU 300. The temperature detector 320 may be, for example, a thermistor.

The optical system 340 is for projecting an image to, for example, a screen 20 by using the laser beam irradiated from the LD 290. The optical system 340 includes, for example, a collimator lens (not illustrated), a polarization beam splitter (not illustrated), and a ¼ wave plate (not illustrated).

Next, the controls performed by the CPU 200 according to an embodiment of the present invention are described.

The CPU 200 and the driver IC 300 exchange image data via an address (ADR) bus 201 and a data bus 202. For example, the CPU 200 designates an address of a storage part (e.g., VRAM 700) of the driver IC 300 with the address bus 201.

For example, in a case where the CPU 200 desires to operate the mirror drive voltage generation part 500 of the driver IC 300, the CPU 200 selects the mirror drive generation part 600 by transmitting a −CS1 signal to the mirror drive voltage generation part 500. Likewise, in a case where the CPU 200 desires to operate the mirror drive voltage generation part 600 of the driver IC 300, the CPU 200 selects the mirror drive voltage generation part 600 by transmitting a −CS2 signal to the mirror drive voltage generation part 600.

Further, in a case where the CPU 200 desires to read, for example, image data from the driver IC 300, the CPU 200 activates (switches on to high level) a −RD (read) signal and transmits the activated −RD signal to the driver IC 300. In a case where the CPU 200 desires to record (store), for example, image data in the driver IC 300, the CPU 200 activates (switches on) a −WR (write) signal and transmits the activated −WR signal to the driver IC 300. In a case where the CPU 200 desires to reset the driver IC 300, the CPU 200 activates (switches on) a −RESET signal and transmits the activated −RESET signal to the driver IC 300.

Next, the driver IC 300 according to an embodiment of the present invention is described. The driver IC 300 supplies a clock signal to the LD driver 280 for driving the LD driver 280. Further, the driver IC 300 supplies an −Enable signal to the LD driver 280 for enabling (validating) the LD driver 280. The LD driver 280 controls the LD 290 when the LD driver 280 is enabled by the driver IC 300. Further, the driver IC 300 outputs a timing signal indicating to start the writing of image data to the LD driver 280.

Next, the driver IC 300 according to an embodiment of the present invention is described in further detail with reference to FIG. 6.

In addition to the mirror drive voltage generation parts 500, 600, and the VRAM 700, the driver IC 300 also includes counter clocks (counter clock generation parts) 350, 360, a horizontal direction (X direction) address counter 370, and a vertical direction (Y direction) address counter 380. The counter clock 350 supplies a clock signal to the horizontal direction address counter 370. The counter clock 360 supplies a clock signal to the vertical direction address counter 380.

The horizontal direction address counter 370 counts horizontal direction addresses of the VRAM 700. The vertical direction address counter 380 counts vertical direction addresses of the VRAM 700. The VRAM 700 according to an embodiment of the present invention includes a two-dimensional address space formed of the horizontal direction addresses (X addresses) and the vertical direction addresses (Y addresses). The two-dimensional address space of the VRAM 700 is for storing image data therein. In this embodiment, the VRAM 700 includes X addresses of 8 bits and Y addresses of 8 bits. It is to be noted that the horizontal direction corresponds to the X1-X2 directions of FIG. 5 and the vertical direction corresponds to the Y1-Y2 directions of FIG. 5.

Next, the mirror drive voltage generation parts 500, 600 are described in further detail. The mirror drive control generation parts 500, 600 according to an embodiment of the present invention generate mirror drive signals for driving the mirror part 410 by changing duty values of pulse waves by performing modulation such as PWM (Pulse Width Modulation).

The mirror drive generation part 500 according to an embodiment of the present invention refers to the table 231 stored in the ROM 230 and generates a timing signal for resetting the horizontal address counter 370. In this embodiment, the X address of the VRAM 700 becomes “0” when the horizontal address counter 370 is reset. In other words, the timing for starting the writing of image data in the horizontal direction can be determined (defined) by resetting the horizontal address counter 370.

Furthermore, the mirror drive voltage generation part 600 according to an embodiment of the present invention refers to the table 232 stored in the ROM 230 and generates a timing signal for resetting the vertical address counter 380. In this embodiment, the Y address of the VRAM 700 becomes “0” when the horizontal address counter 380 is reset. In other words, the timing for starting the writing of image data in the vertical direction can be determined (defined) by resetting the vertical address counter 380.

The mirror drive voltage generation part 500 according to an embodiment of the present invention includes, for example, a counter clock (counter clock generation part) 510, a sinusoidal wave data address counter 520, an address decoder 530, a sinusoidal wave value storage RAM 540, a PWM generation part 550, a timing register 560, and a timing generator 570.

The counter clock 510 generates a clock signal and supplies the generated clock signal to the sinusoidal wave data address counter 520. The sinusoidal wave data address counter 520 counts the address of the sinusoidal wave value storage RAM 540 according to the clock signal received from the counter clock 510. The address decoder 530 decodes the address counted by the sinusoidal wave data address counter 520.

The sinusoidal wave value storage RAM 540 stores a sinusoidal wave value(s) used for generating a sinusoidal wave(s). One example of the sinusoidal wave value is a duty value of a PWM signal. Assuming that a single cycle of a sinusoidal wave is divided into 256 points, the sinusoidal wave value storage RAM 540 stores the duty values corresponding to the points. In other words the sinusoidal wave value storage RAM 240 stores 256 duty values with respect to a single sinusoidal wave cycle. The PWM generation part 550 generates voltages corresponding to the duty values stored in the sinusoidal wave value storage RAM 540 and outputs the generated voltages as mirror drive voltages of the sinusoidal wave.

The timing register 560 has stored addresses corresponding to timings for generating timing signals. The addresses stored in the timing register 560 are the addresses stored in the sinusoidal wave value storage RAM 540. The timing generator 570 generates a timing signal when the address counted by the sinusoidal wave data address counter 520 matches the address stored in the timing register 560 and outputs the generated timing signal to the horizontal direction address counter 370. The horizontal address counter 370 is reset upon receiving the timing signal from the timing generator 370. Thereby, the count value of the X address of the VRAM 700 becomes 0. When the count value of the X address of the VRAM 700 becomes 0, the driver IC 300 outputs a signal instructing the LD driver 280 to start the driving (illumination) of the LD 290.

With the above-described embodiment, the mirror drive voltage generation part 500 can determine the timing for starting the writing of image data in the X-direction when the address of the sinusoidal wave value storage RAM 40 matches the address stored in the timing register 560. Further, with the above-described embodiment, because a single cycle of a sinusoidal wave equivalent to a mirror drive voltage is divided into 256 points, the timing of starting the writing of image data can be controlled at intervals of T/256 where a single cycle of a sinusoidal wave is indicated as “T”.

Next, the address stored in the timing register 560 according to an embodiment of the present invention is described. The address stored in the timing register 560 according to an embodiment of the present invention is set based on the temperature of the mirror part 410 detected by the temperature detector 320 and the table 231 of the ROM 230.

FIG. 7 illustrates an example of the table 231 stored in the ROM 230 according to an embodiment of the present invention.

The table 231 lists a temperature(s) of the mirror part 410 in correspondence with an address value(s) of the sinusoidal wave value storage RAM 540.

In the table 231, the phase difference between the displacement of the mirror part 410 relative to the X1-X2 directions and the mirror drive voltage is indicated as the address value of the sinusoidal wave value storage RAM 540.

In this embodiment, the sinusoidal wave value, which is stored in an address of the sinusoidal wave value storage RAM 540 corresponding to an address value decoded by the address decoder 530, is output from the sinusoidal wave value storage RAM 540 to the PWM generation part 550. The PWM generation part 550 outputs a voltage corresponding to the sinusoidal wave value as a mirror drive voltage.

The voltage output from the PWM generation part 550 corresponds to the amplitude of the mirror drive voltage (sinusoidal wave). In this embodiment, owing to a one-on-one relationship between the amplitude of the sinusoidal wave and the phase of the mirror drive voltage, the phase of mirror drive voltage output from the PWM generation part 550 can be identified by the amplitude of the mirror drive voltage corresponding to the PWM duty value.

The following example is a case where the phase difference between the mirror drive voltage and the displacement of the mirror part 410 is 360×10/256 degrees when the temperature of the mirror part 410 is “H”.

In this example, the table 231 indicates the temperature “H” in correspondence with the address in which the PWM duty value corresponding to the phase difference “360×10/256 degrees” is stored. In this example, the address in which the PWM duty value corresponding to the phase difference 360×10/256 degrees is stored is “10”.

The CPU 200 sets (stores) the address “10” corresponding to the detection results of the temperature detector 320 in the timing register 560. When the counter value of the sinusoidal wave data address counter 520 matches the address “10” stored in the timing register 560, the timing generator 570 outputs a timing signal to reset the horizontal direction address counter 370. When the horizontal direction address counter 370 is reset, the driver IC 300 instructs the LD driver 280 to drive (illuminate) the LD 290 in order to start the writing of the image data stored in the RAM 700.

Accordingly, when the amplitude of the mirror drive voltage becomes a value matching the PWM duty value of address 10, the timing generator 570 outputs a timing signal at a timing delayed for a phase of 360×10/256 degrees.

With the above-described embodiment, the writing of image data relative to the X1-X2 directions can be started at a timing cancelling out the phase difference between the displacement of the mirror part 410 relative to the X1-X2 directions and the mirror drive voltage.

The table 231 of the above-described embodiment is obtained from the results of measuring the phase difference between the displacement of the mirror part 410 relative to the X1-X2 directions and the mirror drive voltage in various ambient temperatures prior to, for example, the shipping of the optical scanning apparatus 100.

With the above-described embodiment, owing to 256 duty values stored in the sinusoidal wave value storage RAM 540, the timing of starting the writing of image data can be specifically determined at minute intervals in correspondence with the changes of temperature of the mirror part 410.

The storing (setting) of the address in the timing register 560 may be performed by the CPU 200 when, for example, the power of the optical scanning apparatus 100 is switched on. Alternatively, the CPU 200 may perform the storing (setting) of the address in the timing register 560 at predetermined periodic intervals.

The timing generator 570 according to an embodiment of the present invention may report the timing for switching the method of counting (e.g., from addition to subtraction or from subtraction to addition) to the horizontal direction address counter 370. For example, the timing for switching the method of counting may be a point where phase deviates 180 degrees from a point of the horizontal direction address counter 370 corresponding to address 0. Accordingly, the timing generator 570 may output a switch report signal to the horizontal direction address counter 370 for reporting the timing for switching the method of counting. Then, the horizontal direction address counter 370 switches the method of counting from addition to subtraction or from subtraction to addition in accordance with the switch report signal from the timing generator 570.

With the above-described embodiment, in a case where, for example, the scanning direction of the laser beam reflected from the mirror part 410 is from X1 to X2, the counter value of the X address of the VRAM 700 may be incremented (addition). In a case where, for example, the scanning direction of the laser beam reflected from the mirror part 410 is from X2 to X1, the counter value of the X address of the VRAM 700 may be decremented (subtraction). Accordingly, writing of the image data stored in the VRAM 700 can be started in correspondence with the displacement of the mirror part 410.

In the above-described embodiment, it is described that the counter value of the X address of the VRAM 700 is incremented when the scanning direction is from X1 to X2 and that the counter value of the X address of the VRAM 700 is decremented when the scanning direction is from X2 to X1. However, in a case where the left side and right side of an image to be displayed (projected) is to be inverted, the counter value of the X address of the VRAM 700 may be decremented when the scanning direction is from X1 to X2 and the counter value of the X address of the VRAM 700 may be incremented when the scanning direction is from X2 to X1.

Next, the mirror drive voltage generation part 600 according to an embodiment of the present invention is described. The mirror drive voltage generation part 600 according to an embodiment of the present invention includes, for example, a counter clock (counter clock generation part) 610, a sinusoidal wave data address counter 620, an address decoder 630, a sinusoidal wave value storage RAM 640, a PWM generation part 650, a timing register 660, and a timing generator 670. The mirror drive voltage generation part 600 has substantially the same configuration as the mirror drive voltage generation part 500. Thus, the mirror drive voltage generation part 600 controls the timing for starting the writing of image data in the Y-direction by referring to the table 232 stored in the ROM 230. Furthermore, the timing generation 670 according to an embodiment of the present invention may report the timing for switching the method of counting (e.g., from addition to subtraction or from subtraction to addition) to the vertical direction address counter 380.

Because there are characteristics that are unique to the piezoelectric type mirror 400, it is preferable to prepare the tables 231, 232 based on measurement results obtained from each independent piezoelectric type mirror 400.

With the above-described embodiment, the writing of image data relative to the X1-X2 directions and the Y1-Y2 directions can be started at a timing that cancels out the phase difference between the displacement of the mirror part 410 relative to the X1-X2 directions and the mirror drive voltage.

In the above-described embodiment, a biaxial piezoelectric type mirror is used for describing the piezoelectric type mirror 400. However, a single axis piezoelectric type mirror may be used as the piezoelectric type mirror 400.

In an exemplary case where the piezoelectric type mirror 400 is configured as a single axis piezoelectric type mirror, the mirror 410 is oscillated only in, for example, the X1-X2 directions by the first cantilevers 411, 412. The first cantilevers 411, 412 may be supported by the outer frame 415.

Further, in the exemplary case where the piezoelectric type mirror 400 is configured as a single axis piezoelectric type mirror, the optical scanning apparatus 100 may be without the LPF 250, the AMP 270, and the inverter 271. Further, in the exemplary case, the ROM 230 may be without the table 232 and include only the table 231. Further, in the exemplary case, the driver IC 300 may be without the mirror drive voltage generation part 600, the counter clock 360, and the vertical direction address counter 380.

In the above-described embodiment, the driver IC 300 includes the VRAM 700. However, the VRAM 700 may be provided outside of the VRAM 700. Further, although the ROM 230 is illustrated outside of the driver IC 300, the ROM 230 may be provided inside the driver IC 300. Further, although a single cycle of a sinusoidal wave is divided into 256 parts, the cycle of the sinusoidal wave may be divided into parts other than 256. That is, the cycle of the sinusoidal wave may be divided into a discretional number of parts. Accordingly, the sinusoidal wave value storage RAM 540, 640 may store PWM duty values in a number corresponding to the discretional number of divided parts of the sinusoidal wave.

In the above-described embodiment, the optical scanning apparatus 100 includes the PWM generation parts 550, 650 and the LPFs 240, 250. Alternatively, each of the PWM generation parts 550, 650, the LPFs 240, 250 may be replaced with a DAC (Digital to Analog Converter).

In the above-described embodiment, the mirror 410 is a piezoelectric type mirror driven by a piezoelectric element. However, the mirror 410 may be an electrostatic type mirror driven by electrostatic force or an electromagnetic type mirror driven by electromagnetic force. Thus, mirror 410 according to an embodiment is a mirror configured to oscillate in accordance with resonance (sympathetic vibration).

Further, the optical scanning apparatus 100 of the above-described embodiment may be used not only for a projector that projects image data but also for an image forming apparatus, for example.

### Second Embodiment

An optical scanning apparatus 100A according to the second embodiment of the present invention is described with reference to FIG. 8. The optical scanning apparatus 100A of the second embodiment is different from the optical scanning apparatus 100 of the first invention from an aspect that the image data, which are to be projected, are read out from a storage part. Accordingly, the different aspect of the optical scanning apparatus 100A compared to the optical scanning apparatus 100 is mainly described. Thus, in the optical scanning apparatus 100A illustrated in FIG. 8, like components are denoted with like reference numerals as those of the optical scanning apparatus 100 and are not further described.

For example, a laser pointer may be used for projecting a predetermined image because the optical scanning apparatus 100A of the second embodiment is capable of projecting images based on image data stored in a storage part. For example, the optical scanning apparatus 100A can project image data discretionally selected from image data stored in the storage part.

FIG. 8 is a schematic diagram illustrating the optical scanning apparatus 100A according to the second embodiment of the present invention. The optical scanning apparatus 100A of the second embodiment includes a CPU 200A, a driver IC 300A, DACs 240A, 250A, a memory device 420, and a control part 430.

Next, functions of the CPU 200A are described. In addition to the ADC 330, the CPU 200A also includes a function selection part 201, an image selection part 202, an image readout part 203, and an interface part 204.

The function selection part 201 selects whether the optical scanning apparatus 100A is to function as a laser pointer or a device other than a laser pointer (e.g., a projector). For example, in a case of obtaining image data from a PC 110, the optical scanning apparatus 100A may function as a device other than a laser pointer. Further, in a case of reading out image data from an external storage part via the memory device 420 or the interface part 204, the optical scanning apparatus 100A may function as a laser pointer.

The image selection part 202 selects image data to be read out from image data stored in the memory device 420 or an external storage part according to controls performed on the control part 430. The image readout part 203 reads out the image data selected by the image selection part 202 and records (writes) the read out image data to the VRAM 700 of the driver IC 300A. Thereby, image data are be stored in the VRAM 700.

The interface part 204 is an interface with respect to an external storage part externally connected to the optical scanning apparatus 100A. The external storage part may be, for example, a transportable type recording medium (e.g., USB (Universal Serial Bus) memory, an SD card). It is preferable for the optical scanning apparatus 100A to have a USB port and/or an SD card slot.

The driver IC 300A includes mirror drive voltage generation parts 500A, 600A. The output of the mirror drive voltage generation part 500A is supplied to the DAC 240A. The output of the mirror drive voltage generation part 600A is supplied to the DAC 250A. Details of the driver IC 300A are described below.

The memory device 420 in this embodiment may be, for example, a hard disk drive. Image data may be stored in the hard disk drive beforehand. The image data stored in the memory device may be image data obtained from, for example, the PC 110.

The control part 430 in this embodiment is for operating (maneuvering) the optical scanning apparatus 100A. By operating the control part 430, the optical scanning apparatus 100A can be operated to function as a laser pointer. Further, the image to be projected by the optical scanning apparatus 100A can be switched by operating the control part 430. That is, image data may be selected by operating the control part 430.

Next, the driver IC 300A according to an embodiment of the present invention is described with reference to FIG. 9. FIG. 9 is a schematic diagram illustrating the driver IC 300A according to the second embodiment of the present invention.

The driver IC 300A according to an embodiment of the present invention includes mirror drive voltage generation parts 500A, 600A. Unlike the mirror drive voltage generation part 500 of the first embodiment, the mirror drive voltage generation part 500A of the second embodiment does not include the PWM generation part 550. Unlike the mirror drive voltage generation part 600 of the first embodiment, the mirror drive voltage generation part 600A of the second embodiment does not include the PWM generation part 650.

In the second embodiment, the DAC 240A acts as the PWM generation part 550 and the LPF 240. Likewise, the DAC 250A acts as the PWM generation part 650 and the LPF 250.

With the above-described embodiment, image data can be discretionally read out from an external storage part connected to the optical scanning apparatus 100A via the memory device 240 or the interface part 204. Accordingly, the shape of the projected image (pointer) can be changed by operating the control part 430 according to circumstance, such as a case of using the optical scanning apparatus 100A as a laser pointer for a presentation or the like.

With the above-described embodiment, an image can selected from a vast amount of image data since images can be obtained from the memory device 420 or an external storage part storing sufficient amount of data.

With the above-described embodiment, the optical scanning apparatus 100A can be used as a USB memory by providing a USB port in the optical scanning apparatus 100A. Accordingly, the optical scanning apparatus 100A can carry image data to be projected for a presentation or the like. With the above-described embodiment, the optical scanning apparatus 100A can be used as a pointing device by providing a SD card slot in the optical scanning apparatus 100A. Accordingly, the optical scanning apparatus 100A can be used as a pointing device reading out image data (e.g., image data taken from a digital camera or a mobile phone) stored in the SD card and using the image data as a pointer.

Further, the present invention is not limited to these embodiments, but variations and modifications may be made without departing from the scope of the present invention.

The present application is based on Japanese Priority Application Nos. 2010-037290 and 2010-222287 filed on Feb. 23, 2010 and Sep. 30, 2010, respectively, with the Japanese Patent Office, the entire contents of which are hereby incorporated by reference.

What is claimed is:

1. An optical scanning apparatus for projecting an image by scanning a light beam from a light source, the optical scanning apparatus comprising:
a mirror configured to scan the light beam from the light source by being oscillated at a resonance frequency; and
a drive control part configured to control a timing for activating the light source;
wherein the drive control part includes
a mirror drive voltage generation part configured to generate a mirror drive voltage for oscillating the mirror;
a sinusoidal wave value storage part configured to store a sinusoidal wave value used for generating the mirror drive voltage;
an address counter configured to count an address of the sinusoidal wave storage part; and
a timing signal generation part configured to output a timing signal to control the timing for activating the light source to the drive control part;
wherein the timing signal generation part is configured to output the timing signal when the address of the sinusoidal wave storage part matches a predetermined address.

2. The optical scanning apparatus as claimed in claim 1, further comprising:
a table storage part configured to store a table indicating a predetermined address value in correspondence with a temperature of the mirror, the predetermined address value indicating an address of the sinusoidal wave value stored in the sinusoidal wave value storage part that corresponds to a phase difference between the mirror drive voltage and displacement of the mirror; and
a temperature detection part configured to detect the temperature of the mirror;
wherein the predetermined address is set based on the table and the temperature detected by the temperature detection part.

3. The optical scanning apparatus as claimed in claim 1, wherein the sinusoidal wave value storage part is configured to store 256 sinusoidal wave values with respect to a single cycle of a sinusoidal wave.

4. The optical scanning apparatus as claimed in claim 1, wherein the mirror is a piezoelectric type mirror configured to be oscillated by a cantilever.

5. The optical scanning apparatus as claimed in claim 1, further comprising:
an image readout part configured to read out one or more image data items from an image data storage part storing the one or more image data items; and
an optical system configured to project the image according to the one or more image data items read out by the image readout part.

6. The optical scanning apparatus as claimed in claim 5, further comprising:
an image selection part configured to select the one or more image data items stored in the image data storage part;
wherein the image readout part is configured to read out the one or more image data items selected by the image selection part.

7. The optical scanning apparatus as claimed in claim 6, wherein the image data storage part is a memory device installed in the optical scanning apparatus.

8. The optical scanning apparatus as claimed in claim 6, wherein the image data storage part is a recording medium that can be read out by the image readout part.

9. A drive control circuit for controlling a timing for activating a light source that irradiates a light beam to an oscillating mirror, the drive control circuit comprising:
a generation part configured to generate a mirror drive voltage for oscillating the mirror;
a sinusoidal wave value storage part configured to store a sinusoidal wave value used for generating the mirror drive voltage;
an address counter configured to count an address of the sinusoidal wave storage part; and
a timing signal generation part configured to output a timing signal to control the timing for activating the light source;
wherein the timing signal generation part is configured to output the timing signal when the address of the sinusoidal wave storage part matches a predetermined address.

10. A writing control method for controlling a timing for activating a light source that irradiates a light beam to an oscillating mirror, the method comprising the steps of:
generating a mirror drive voltage for oscillating the mirror;
counting an address of a sinusoidal wave storage part; and
determining a timing for outputting a timing signal to control the timing for activating the light source;
wherein the timing signal is output when the address of the sinusoidal wave storage part matches a predetermined address.
